(19) United States
(12) Patent Application Publication
(10) Pub. No.: US 2013/0334481 A1
(43) Pub. Date: Dec. 19, 2013

(54) COMPACT PORTABLE LIFTING APPARATUS

(71) Applicant: Richard W. Bogert, Kennewick, WA (US)

(72) Inventor: Richard W. Bogert, Kennewick, WA (US)

(21) Appl. No.: 13/908,928

(22) Filed: Jun. 3, 2013

Related U.S. Application Data
(60) Provisional application No. 61/655,895, filed on Jun. 5, 2012.

(51) Int. Cl. B66F 3/36; B66F 3/22

(52) U.S. Cl. CPC B66F 3/36; B66F 3/22
USPC 254/93 R; 254/120; 254/131; 254/122

(57) ABSTRACT

A lifting apparatus is provided having an elongated support member and an elongated lift member pivotably coupled together to move between a retracted configuration in which a distal end of the lift member is near a base end of the support member and an expanded configuration in which the distal end of the lift member is remote from the base end of the support member to support a load in an elevated position. A biasing device is coupled between the support member and the lift member to selectively move the lifting apparatus between the retracted configuration and the expanded configuration, a first end of the biasing device pivotably coupled to the base end of the support member and a second end of the biasing device pivotably coupled to the lift member. A base may be pivotably coupled to the support member to engage the ground surface during lifting operations.

### BACKGROUND

1. Technical Field

The present disclosure is directed to lifting devices, and more particularly, to compact portable lifting devices suitable for lifting a vehicle and other heavy loads.

2. Description of the Related Art

Portable lifting devices such as car jacks (e.g., bottle jacks) have conventionally included two opposing supports, one for resting on the ground and the other for mating with an adapter on the vehicle, and a leveraging mechanism positioned between the two supports. Typically, the leveraging mechanism operates to increase the distance between the two supports and raise the vehicle or a portion thereof away from the ground.

These devices suffer from stability drawbacks. For example, conventional car jacks are susceptible to being tipped onto one side upon experiencing a side load. Conventional jacks are typically designed to only withstand vertical loads, which makes them less than ideal for lifting a vehicle that is positioned on an incline or a decline, or that can be subject to non-vertical loads. Furthermore, conventional jacks are not well suited for lifting vehicles having independent suspensions because the vehicles tend to move laterally when lifted due to the articulation of the suspension. Furthermore, the jack support that rests on the ground is typically configured to rest on a flat firm surface. Accordingly, when lifting on an uneven or soft surface, the jack tends to become unstable, further making conventional jacks susceptible to side loads and other loads.

Lifting devices for larger structures, such as trucks and heavy automobiles, further suffer from portability drawbacks. These devices tend to be bulky and heavy, such that in some cases their transport requires a dedicated vehicle. Many of these larger lifting devices are also prone to tipping on their side when exposed to side loads.

Some particularly advantageous lifting devices are described in Applicant's U.S. Pat. No. 8,016,266, which is incorporated herein by reference in its entirety for all purposes. Although the lifting devices described therein are portable and well suited for compensating for lateral loads, the devices typically include a bell crank structure which adds to the complexity and weight of the devices and can limit or restrict their operable range of motion.

### BRIEF SUMMARY

The lifting devices described herein provide for lifting vehicles and other heavy loads in a particularly portable, robust and efficient form factor. Embodiments of the lifting devices are particularly well suited for lifting vehicles and other heavy loads while compensating for lateral loads and/or adjusting to various ground conditions. Furthermore, the lifting devices are particularly compact while maintaining sufficient lift capacity to lift multi-ton vehicles.

According to one embodiment, a lifting apparatus may be summarized as including: a base; a support member having a first end and a second end, the first end of the support member removably pivotably coupled to the base; a lift member having a first end and a second end, the first end of the lift member pivotably coupled to the second end of the support member to move between a retracted configuration in which the second end of the lift member is near the first end of the support member and an expanded configuration in which the second end of the lift member is remote from the first end of the support member; and a biasing device, such as a hydraulic cylinder, having a first end and a second end, the first end of the biasing device pivotably coupled to the first end of the support member and the second end of the biasing device pivotably coupled to the lift member, the biasing device configured to move the lifting apparatus between the retracted configuration and the expanded configuration. The lifting apparatus is configured such that, when the lifting apparatus is in the expanded configuration, a movement of the second end of the lift member caused by a lateral shift in a supported load results in repositioning of the biasing device, the support member and the lift member to compensate for the lateral shift.

According to another embodiment, a lifting apparatus may be summarized as including: an elongated support member having a base end and a joint end; an elongated lift member pivotably coupled to the support member at the joint end to move between a retracted configuration in which a distal end of the lift member is near the base end of the support member and an expanded configuration in which the distal end of the lift member is remote from the base end of the support member to support a load in an elevated position; and a biasing device, such as a hydraulic cylinder, coupled between the support member and the lift member to selectively move the lifting apparatus between the retracted configuration and the expanded configuration, a first end of the biasing device pivotably coupled to the base end of the support member and a second end of the biasing device pivotably coupled to the lift member at an intermediate position between opposing ends thereof.

The lifting apparatus may further include a base pivotably coupled to the base end of the support member to engage a ground surface as the lifting apparatus moves from the retracted configuration to the expanded configuration to support the load. The lifting apparatus may be configured such that, when the lifting apparatus is in the expanded configuration, a movement of the distal end of the lift member caused by a lateral shift in the supported load results in repositioning of the biasing device, the support member and the lift member to compensate for the lateral shift. This is also true of intermediate positions between the retracted configuration and the expanded configuration. In other words, the lifting apparatus may compensate for a lateral shift throughout a full range of operation.

The lifting apparatus may further include a coupling member rotatably coupled to the distal end of the lift member to engage a portion of the load when lifting the same. The support member and the lift member may form an adjustable jaw mechanism in which the distal end of the lift member moves away from the base end of the lift member to lift the load. A nose of the lifting apparatus may be positionable within a restricted space with the nose below a height of five inches from a ground surface. The lifting apparatus may be configured to displace the load at least twelve inches from an initial height within five inches of a ground surface. The lifting apparatus may be sized to fit within a compact space measuring seven inches wide, eighteen inches long, and eight inches tall while having a lift capacity of at least three tons. In other instances, the lifting apparatus may be sized to fit within a compact space measuring four inches wide, fifteen inches long, and five inches tall while having a lift capacity of at least two tons.

### BRIEF DESCRIPTION OF THE SEVERAL VIEWS OF THE DRAWINGS

FIG. 1 is an isometric view of a lifting apparatus, according to one embodiment, shown in an expanded configuration lifting a load in the form of a vehicle.

FIG. 2 is an isometric view of the lifting apparatus of FIG. 1 in a retracted configuration.

FIG. 3 is another isometric view of the lifting apparatus of FIG. 1 in a retracted configuration.

FIG. 4 is a top plan view of the lifting apparatus of FIG. 1 in a retracted configuration.

FIG. 5 is a side elevational schematic view of the lifting apparatus of FIG. 1 illustrating the range of motion of the lifting apparatus between the retracted and expanded configurations.

FIG. 6 is a side elevational view of the main lifting structure of the lifting apparatus of FIG. 1 illustrating the lifting apparatus in the expanded configuration.

FIG. 7 is an isometric view of a lifting apparatus, according to another embodiment, shown in an expanded configuration.

FIG. 8 is an isometric view of a lifting apparatus, according to yet another embodiment, shown in a retracted configuration.

FIGS. 9 is a perspective view of the lifting apparatus of FIG. 8 shown in the retracted configuration and positioned beneath a load to be lifted.

FIGS. 10 is a perspective view of the lifting apparatus of FIG. 8 shown in an expanded configuration lifting the load.

FIG. 11 is a partial isometric view of a lifting apparatus according to one embodiment having a coupling element rotatably coupled to the nose thereof.

### DETAILED DESCRIPTION

In the following description, certain specific details are set forth in order to provide a thorough understanding of various disclosed embodiments. However, one skilled in the relevant art will recognize that embodiments may be practiced without one or more of these specific details. In other instances, well-known structures and devices associated with lifting devices, such as, for example, hydraulic vehicle jacks and the like, may not be shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

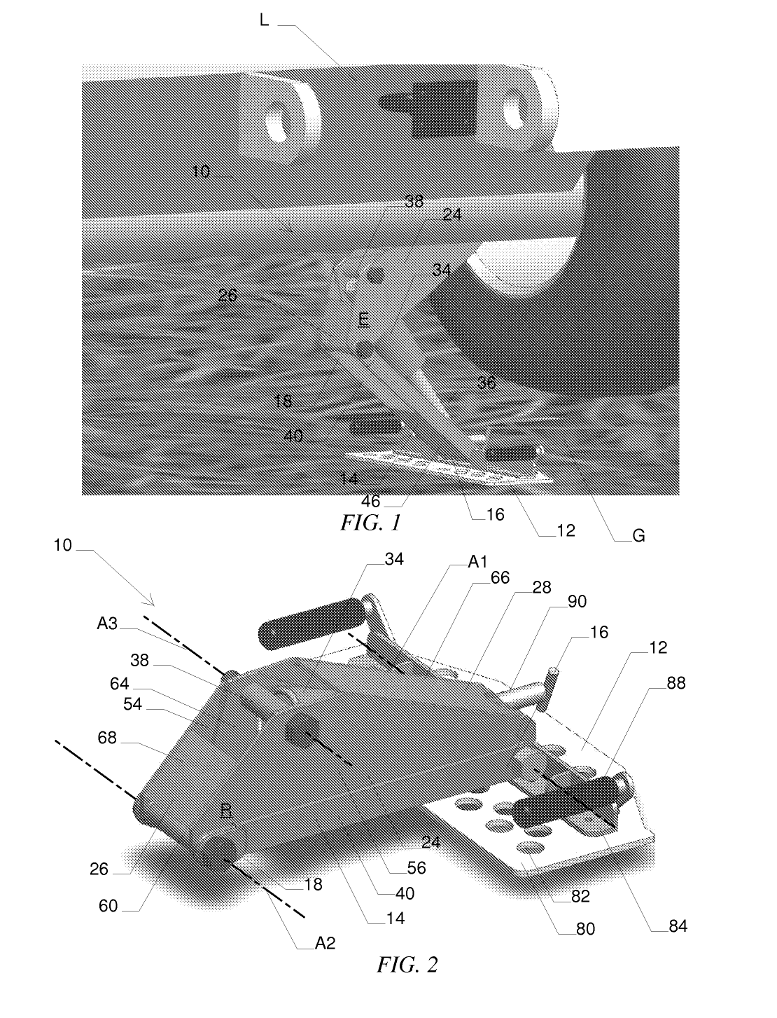

FIG. 1 shows a lifting apparatus 10, according to one example embodiment, in an expanded configuration E. The lifting apparatus 10 is shown engaging a ground surface G and supporting a load L in the form of a vehicle. More particularly, a base 12 of the lifting apparatus is positioned against the ground surface G and the load L is supported by a lift structure comprising a support member 14, a lift member 24 and a biasing device 34 coupled therebetween. The support member 14 is pivotably coupled to the lift member 24 to form an adjustable jaw mechanism in which a distal end 28 (FIGS. 2 through 6) of the lift member 24 is movable away from a base end 16 of the support member 14 to lift the load L. In some embodiments, the support member 14 may form an adjustable acute angle with the lift member 24.

The biasing device 34 (e.g., hydraulic cylinder) is coupled between the support member 14 and the lift member 24 to selectively open and close the jaw mechanism. In the expanded configuration E shown in FIG. 1, the support member 14, the lift member 24 and the biasing device 34 collectively form a rigid support structure which is pivotable at the base end 16 to the base 12. In this manner, the lifting apparatus 10 can compensate or adjust for lateral shifts in the load L or shifting of the ground surface G beneath the base 10.

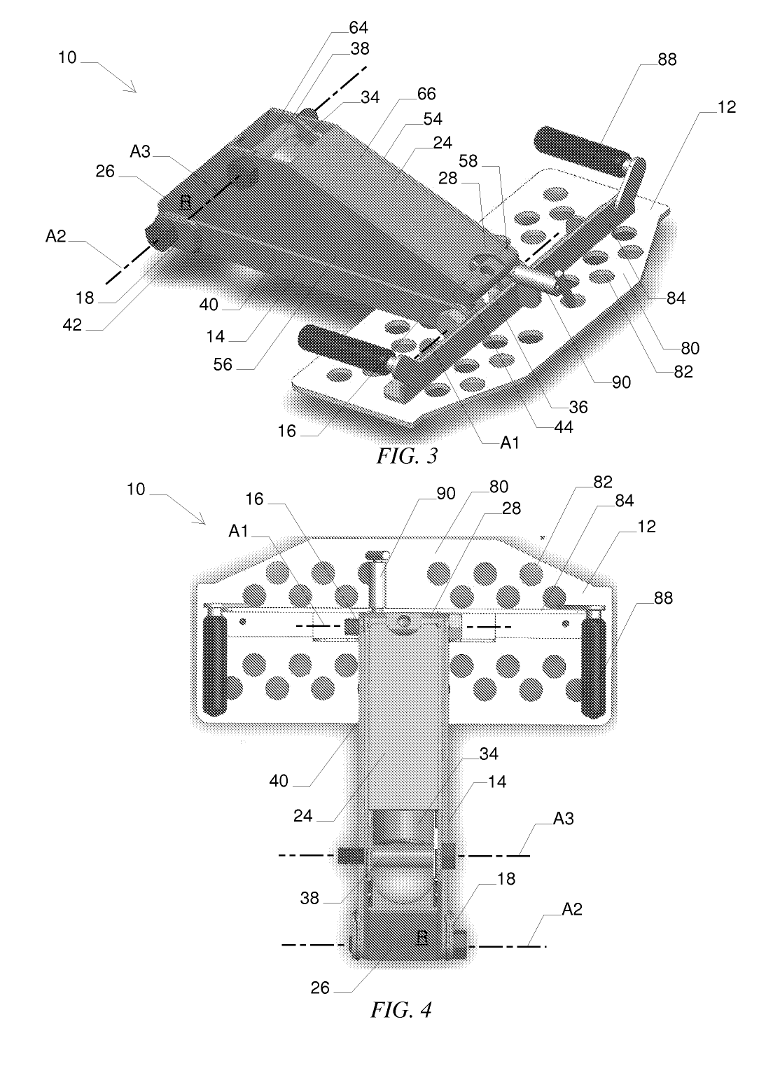

FIGS. 2 and 3 each show the lifting apparatus 10 in a retracted configuration R, wherein the support member 14 is generally parallel to the lift member 24. As previously described, the lifting apparatus 10 includes a base 12 which is adapted to engage the ground when lifting a load L, a support member 14, a lift member 24, and a biasing device 34 coupled between the support member 14 and the lift member 24. More particularly, the support member 14 includes a first end 16 (or base end) and a second end 18 (or joint end), the first end 16 of the support member 14 being pivotably coupled to the base 12 to rotate about a first axis A1, and the lift member 24 includes a first end 26 (or joint end) and a second end 28 (or distal end), the first end 26 of the lift member 24 being pivotably coupled to the second end 18 of the support member 14 to rotate about a second axis A1 to move between the retracted configuration R in which the second end 28 of the lift member 24 is near the first end 16 of the support member 14 and the expanded configuration E (FIGS. 1, 5 and 6) in which the second end 28 of the lift member 24 is remote from the first end 16 of the support member 14 to lift and support the load L at an elevated position.

With continued reference to FIGS. 2 and 3, the biasing device 34 includes a first end 36 (FIGS. 1, 3, 5 and 6) and a second end 38, the first end 36 of the biasing device 34 being pivotably coupled to the first end 16 of the support member 14 and the second end 38 of the biasing device 36 being pivotably coupled to the lift member 24. The biasing device 34 is configured to move the lifting apparatus 10 between the retracted configuration R and the expanded configuration E (FIGS. 1, 5 and 6). Advantageously, the lifting apparatus 10 is configured such that, when the lifting apparatus 10 is in the expanded configuration E (FIGS. 1, 5 and 6), movement of the second end 28 of the lift member 24 which may be caused by a lateral shift in the supported load L results in repositioning of the biasing device 34, the support member 14 and the lift member 24 to compensate for the same. This is also true of intermediate positions between the retracted configuration R and the expanded configuration E. In other words, the lifting apparatus 10 may compensate for a lateral shift throughout a full range of operation. More particularly, the biasing device 34, the support member 14 and the lift member 24 may rotate in unison about the first axis A1 at the first end 16 of the support member 14 to compensate for the lateral shift of the load L. In a similar fashion, shifts in the ground surface G against which the load L is supported may be compensated for by corresponding movements of the lifting apparatus 10.

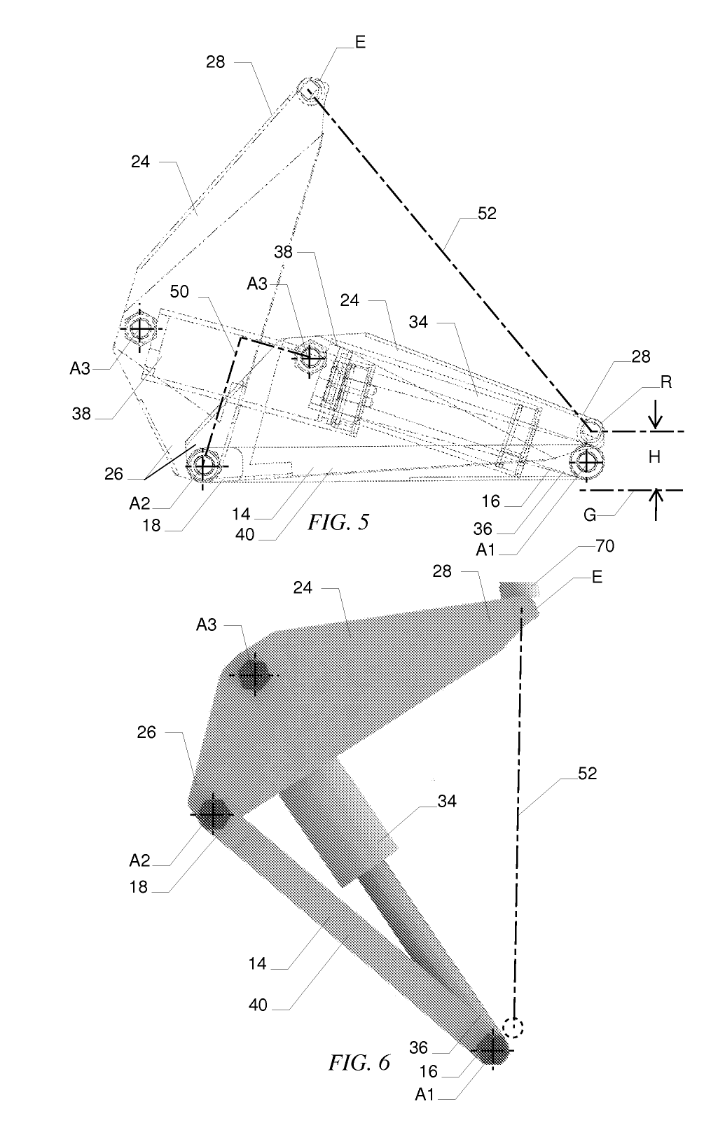

As can be appreciated from FIGS. 2 and 3, the first end 28 (or distal end) or the lift member 24 is positioned in close proximity to the first end 16 (or base end) of the support member 14 to form a nose that can be positioned under the load L for subsequent lifting. The nose may be positionable within a relatively confined or restricted area. For instance, in some embodiments, the nose of the lifting apparatus 10 is positionable within a restricted space with the nose below a height of five inches from the ground surface G. The biasing device 34 is configured relative to the support member 14 and the lift member 24 to provide a substantial lifting force from this compact configuration. In some embodiments, the biasing device 34 is a hydraulic cylinder and includes an initial moment arm 50 (FIG. 5) of at least four inches relative to the second axis A2 at the joint formed between the second end 18 (or joint end) of the support member 14 and the first end 26 (or joint end) of the lift member 24. The lifting apparatus 10 may be configured to displace the load L a range 52 (FIGS. 5 and 6) of at least twelve inches from an initial height H (FIG. 5) within five inches of the ground surface G. In other embodiments, the lifting apparatus 10 may have a greater or more limited range 52 of motion.

In the retracted configuration R, the support member 14 and the lift member 24 may be generally parallel, as shown in FIGS. 2 and 3. In addition, when the lifting apparatus 10 is in the retracted configuration R, the biasing device 34 may be located within an outer perimeter profile of the support member 14 and the lift member 24 when viewed from a side of the lifting apparatus 10. In this manner, the biasing device 34 may be contained within an interior envelope of the main lifting structure of the lifting apparatus 10.

The lifting apparatus 10 may be relatively compact while maintaining sufficient lift capacity to lift multi-ton vehicles and the like. For example, the support member 14, lift member 24 and biasing device 34 of the lifting apparatus 10 may be sized to fit within a compact space measuring seven inches wide, eighteen inches long, and eight inches tall while having a lift capacity of at least three tons over at least a ten inch lifting range 52 (FIGS. 5 and 6). In other embodiments, the support member 14, lift member 24 and biasing device 34 of the lifting apparatus 10 may be sized to fit within a compact space measuring four inches wide, fifteen inches long, and five inches tall while having a lift capacity of at least two tons over at least a ten inch lifting range 52 (FIGS. 5 and 6).

With reference to FIGS. 1 through 6, the support member 14 may include a pair of elongated arms 40 each having a first end and a second end, the first end of each elongated arm 40 being pivotably coupleable to the base 12, and the second end of each elongated arm 40 being pivotably coupleable to the first end 26 (or joint end) of the lift member 24. The elongated arms 40 may be plate or bar stock and the support member 14 may be in the form of a weldment including the elongated arms 40, reinforcement doublers 42 (FIG. 3), bushings 44 (FIG. 3) and/or a transverse spreader 46 (FIG. 1), for example. In other embodiments, the support member 14 may be cast or otherwise formed as a unitary member having a shape similar to or different from that shown in the example embodiment of FIGS. 1 through 6. The support member 14 may be steel or predominately steel or other suitable materials and may be made out of various grades or strengths of material based on expected load conditions and the rated load capacity of the lifting apparatus 10. The first end 16 (or base end) of the support member 14 may define a space or be otherwise configured to receive the first end 36 of the biasing device 34, as shown, for example, in FIG. 3. The second end 18 (or joint end) of the support member 14 may define a space or be otherwise configured to receive the first end 26 (or joint end) of the lift member 24, as shown, for example, in FIG. 1. The lift member 24 may be coupled between opposing portions of the support member 14, such as, for example, between the pair of elongated arms 40. In other embodiments, the support member 14 may be coupled between opposing portions of the lift member 24. For example, the support member 14 may be positioned between ears or lugs of the first end 26 (or joint end) of the lift member 24.

With continued reference to FIGS. 1 through 6, the lift member 24 may include a pair of opposing plates 54, 56 (FIGS. 3 and 4) and the second end 38 of the biasing device 36 may be pivotably coupled to the lift member 24 between the pair of opposing plates 54, 56. More particularly, the lift member 24 may include a first plate 54, a second plate 56 offset from the first plate 54, and a first and a second spacer 58, 60, the first spacer 58 coupling the first plate 54 and second plate 58 and maintaining a substantially constant distance therebetween toward the second end 28 (or distal end) of the lift member 24, the second spacer 60 (FIG. 2) coupling the first plate 54 and second plate 56 and maintaining a substantially constant distance therebetween toward the first end 26 (or joint end) of the lift member 24. The lift member 24 may further include a first and a second stiffening plate 64, 66 coupled to a respective one of the first and second plates 54, 56 to increase the robustness of the lifting apparatus 10. Still further, one or more transverse spreader members 66, 68 (FIGS. 2 and 3) may be provided to span between the opposing sidewall plates 54, 56 to further strengthen the lift member 24. The lift member 24 may be in the form of a weldment including the opposing plates 54, 56, stiffening plates 64, 66, spreader members 66, 68 and/or spacers 58, 60. In other embodiments, the lift member 24 may be cast or otherwise formed as a unitary member having a shape similar to or different from that shown in the example embodiment of FIGS. 1 through 6. The lift member 24 may be steel or predominately steel or other suitable materials and may be made out of various grades or strengths of material based on expected load conditions and the rated load capacity of the lifting apparatus 10.

In some embodiments, the spacer 58 may form a transverse nose member that is configured to act as a coupling to interface with the load L (FIG. 1) when lifting the same. For example, the transverse nose member may include a textured surface to act against the load L. As another example, a separate coupling 70 (FIG. 6) may be attached to the transverse nose member 58 to interface with the load. The coupling 70 may be fixedly attached to the transverse nose member 58 or may be rotatably coupled to the same. For example, FIG. 11 shows one example embodiment of a lifting apparatus 310 in which a coupler or coupling 312 is rotatably coupled to a transverse nose member 314 thereof, as represented by the arrow labeled 316. The coupling 312 is able to pivot or rotate in response to changes in the orientation of the load L and/or the lifting apparatus 310 as it moves between retracted and expanded configurations. The coupling 312 may be a saddle-like device. In this manner, the coupling 312 may engage the load more securely throughout lifting operations.

As shown in FIG. 1 through 4, the base 12 may include a base plate 80 that is configured to support the lifting apparatus 10 against the ground surface G during lifting. The base plate 80 may be a generally planar element with a relatively large footprint to distribute loads over a relatively wide area and to assist in providing a stable footprint on various ground surfaces G, including relatively soft surfaces, such as, for example, sand surfaces. The base plate 80 may include a plurality of apertures 82 to minimize a weight of the same and to further stabilize the base plate 80 when operating on relatively soft surfaces. The support member 14 may be coupled to the base plate 80 via a mounting bracket 84. The mounting bracket 84 may extend transversely across the base plate 80 to stiffen the base 12. In addition, the mounting bracket 84 may include or otherwise be coupled to one or more handles 88 for manipulating and positioning the lifting apparatus 10 for use. A lock mechanism 90 may be provided on the base 12 to secure the support member 14 to the base 12 during positioning of the lifting apparatus 10 to lift a load L.

In operation, the lifting apparatus 10 may be coupled to an external pressure source or other control system for selectively actuating the biasing device 34 and moving the lifting apparatus 10 between the extended and retracted configurations. For example, in some embodiments, the biasing device 34 is a hydraulic or pneumatic cylinder and coupleable to a hand pump which can be used to extend the cylinder and erect the lifting apparatus 10. Pressure may be selectively released to lower or collapse the lifting apparatus 10 toward the retracted configuration R. Accordingly, the lifting system 10 can be carried to remote locations and used without requiring a separate power source. That said, in other embodiments, the lifting apparatus 10 may be coupled to a powered external pressure source, such as, for example, an electric hydraulic or pneumatic pump device.

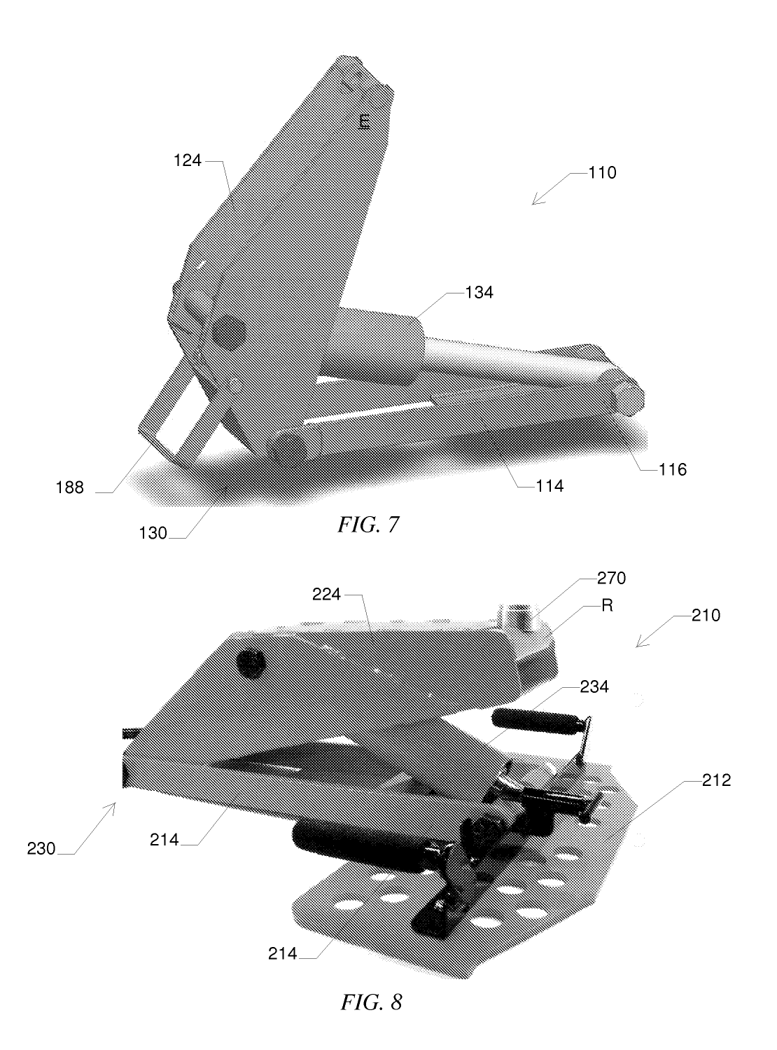

FIG. 7 shows another embodiment of a lifting apparatus 110 which is particularly compact while retaining a relatively high lift capacity. The lifting apparatus 110 includes a jaw-like mechanism including a support member 114 pivotally coupled to a lift member 124 at joint 130. The support member 114 and the lift member 124 are movable between a retracted configuration (not shown) and an extended configuration E via a biasing device 134 coupled therebetween. More particularly, the biasing device 134 is coupled to a base end 116 of the support member 114 distal to the joint 130 and to the lift member 124 in a region between opposing ends thereof. The lifting apparatus 110 may be utilized with a base similar to the previously described base 12, or may be operated without a base. In the latter case, the base end 116 of the support member 114 may engage the ground surface directly while the lift member 124 is pivoted relative to the support member 114 by the biasing device 134 during lifting operations. The lifting apparatus 110 may include a handle 188 for manipulating and positioning the lifting apparatus 110 for use.

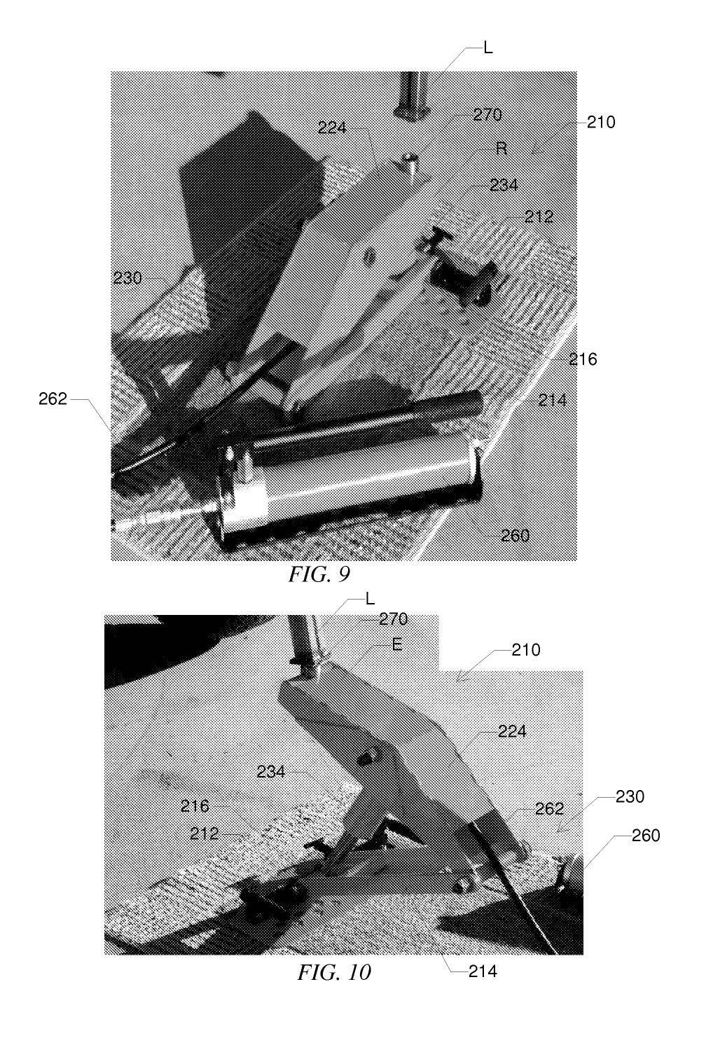

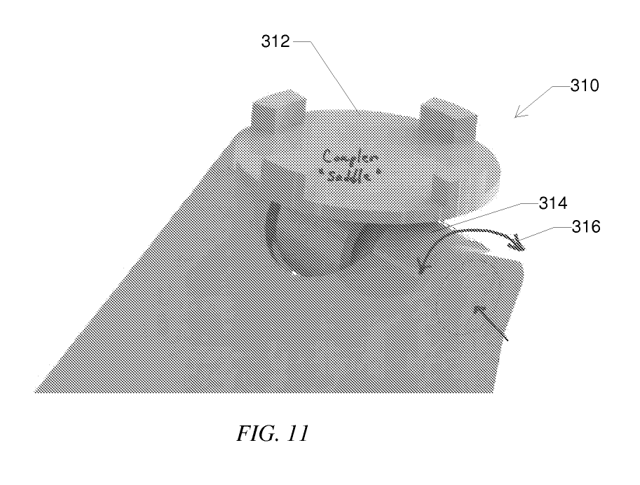

FIGS. 8 through 10 shows yet another embodiment of a lifting apparatus 210 which is particularly robust. The lifting apparatus 210 includes a jaw-like mechanism including a support member 214 pivotally coupled to a lift member 224 at joint 230. The support member 214 and the lift member 224 are movable between a retracted configuration R (FIGS. 8 and 9) and an extended configuration E (FIG. 10) via a biasing device 234 coupled therebetween. More particularly, the biasing device 234 is coupled to a base end 216 of the support member 214 distal to the joint 230 and to the lift member 224 in a region between opposing ends thereof. The lifting apparatus 210 may be utilized with a base 212 similar to the previously described base 12, as shown, or may be operated without a base 212. In the latter case, the base end 216 of the support member 214 may engage the ground surface directly while the lift member 224 is pivoted relative to the support member 214 by the biasing device 234 during lifting operations. The biasing device 234 may be coupled to an external pressure source 260 (FIG. 9), such as a hand pump, via a working fluid conduit 262 to actuate the biasing device 234 and move the lifting apparatus 210 between the extended and retracted positions.

The lifting apparatus 210 may include a coupling 270 attached to a nose thereof to interface with the load L during lifting operations. The coupling 270 may be fixedly attached to the nose or may be movably coupled to the same. For example, as previously described, FIG. 11 shows one example embodiment of a lifting apparatus 310 in which a coupler or coupling 312 is rotatably coupled to a transverse nose member 314 thereof, as represented by the arrow labeled 316.

The coupling 312 is able to pivot or rotate in response to changes in the orientation of the load L and/or the lifting apparatus 310 as it moves between retracted and expanded configurations. The coupling 312 may be a saddle-like device.

Although the lifting apparatus 10, 110, 210, 310 shown and described herein are particularly well suited for lifting heavy vehicles in a robust and efficient form factor, it is appreciated that a lifting apparatus or device according to other embodiments can be scaled to suit specific lifting applications. For example, the lifting apparatus can be smaller for lifting smaller or lighter weight structures, and can be larger for lifting larger or heavier structures.

Moreover, aspects and features of the various embodiments described above can be combined to provide further embodiments. In addition, U.S. Provisional Patent Application No. 61/655,895, filed Jun. 5, 2012, is incorporated by reference for all purposes and aspects of the invention can be modified, if necessary, to employ features, systems, and concepts disclosed in the application to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A lifting apparatus comprising:
a base;
a support member having a first end and a second end, the first end of the support member removably pivotably coupled to the base;
a lift member having a first end and a second end, the first end of the lift member pivotably coupled to the second end of the support member to move between a retracted configuration in which the second end of the lift member is near the first end of the support member and an expanded configuration in which the second end of the lift member is remote from the first end of the support member; and
a biasing device having a first end and a second end, the first end of the biasing device pivotably coupled to the first end of the support member and the second end of the biasing device pivotably coupled to the lift member, the biasing device configured to move the lifting apparatus between the retracted configuration and the expanded configuration, and
wherein the lifting apparatus is configured such that, when the lifting apparatus is supporting a load, a movement of the second end of the lift member caused by a lateral shift in the supported load results in repositioning of the biasing device, the support member and the lift member to compensate for the lateral shift.

2. The lifting apparatus of claim 1, further comprising:
a coupling member coupled to the second end of the lift member to engage a portion of the supported load when lifting the same.

3. The lifting apparatus of claim 1 wherein the support member includes a pair of elongated arms, each of the pair of elongated arms having a first end and a second end, the first end of each elongated arm being pivotably coupled to the base, and the second end of each elongated arm being pivotably coupled to the first end of the lift member.

4. The lifting apparatus of claim 3 wherein the lift member is coupled to the support member between the pair of elongated arms.

5. The lifting apparatus of claim 1 wherein the lift member includes a pair of opposing plates and the second end of the biasing device is pivotably coupled to the lift member between the pair of opposing plates.

6. The lift apparatus of claim 1 wherein the lift member includes a first plate, a second plate, and a first and a second spacer, the first spacer coupling the first plate and second plate and maintaining a substantially constant distance therebetween toward the second end of the lift member, the second spacer coupling the first plate and second plate and maintaining a substantially constant distance therebetween toward the first end of the lift member.

7. The lift apparatus of claim 6 wherein the lift member further includes a first and a second stiffening plate coupled to a respective one of the first and second plates.

8. The lifting apparatus of claim 1 wherein the lift member includes a transverse nose member toward the second end thereof.

9. The lifting apparatus of claim 8, further comprising:
a coupling member movably coupled to the transverse nose member.

10. The lifting apparatus of claim 8 wherein the transverse nose member of the lift member includes a textured surface to act against the load.

11. The lifting apparatus of claim 1 wherein the support member forms an adjustable acute angle with the lift member.

12. The lifting apparatus of claim 1 wherein the base includes a base plate that is configured to support the lifting apparatus against a ground surface.

13. The lifting apparatus of claim 1 wherein the biasing device is a hydraulic or pneumatic cylinder coupleable to an external pressure source.

14. A lifting apparatus comprising:
an elongated support member having a base end and a joint end;
an elongated lift member pivotably coupled to the support member at the joint end to move between a retracted configuration in which a distal end of the lift member is near the base end of the support member and an expanded configuration in which the distal end of the lift member is remote from the base end of the support member to support a load in an elevated position; and
a biasing device coupled between the support member and the lift member to selectively move the lifting apparatus between the retracted configuration and the expanded configuration, a first end of the biasing device pivotably coupled to the base end of the support member and a second end of the biasing device pivotably coupled to the lift member.

15. The lifting apparatus of claim 14 wherein the second end of the biasing device is pivotably coupled to the lift member at an intermediate position between opposing ends thereof.

16. The lifting apparatus of claim 14, further comprising:
a base pivotably coupled to the base end of the support member to engage a ground surface when the lifting apparatus moves from the retracted configuration to the expanded configuration to support the load.

17. The lifting apparatus of claim 14 wherein the lifting apparatus is configured such that, when the lifting apparatus is in the expanded configuration, a movement of the distal end of the lift member caused by a lateral shift in the supported load results in repositioning of the biasing device, the support member and the lift member to compensate for the lateral shift.

18. The lifting apparatus of claim 14, further comprising:
a coupling member rotatably coupled to the distal end of the lift member to engage a portion of the load when lifting the same.

19. The lifting apparatus of claim 14 wherein the support member and the lift member form an adjustable jaw mechanism in which the distal end of the lift member moves away from the base end of the support member to lift the load.

20. The lifting apparatus of claim 14 wherein the support member and the lift member are generally parallel in the retracted configuration.

21. The lifting apparatus of claim 14 wherein a nose of the lifting apparatus is positionable within a restricted space with the nose below a height of five inches from a ground surface.

22. The lifting apparatus of claim 14 wherein the lifting apparatus is configured to displace the load at least twelve inches from an initial height within five inches of a ground surface.

23. The lifting apparatus of claim 14 wherein, when the lifting apparatus is in the retracted configuration, the biasing device is located within an outer combined profile of the support member and the lift member when viewed from a side of the lifting apparatus.

24. The lifting apparatus of claim 14 wherein the lifting apparatus is sized to fit within a compact space measuring seven inches wide, eighteen inches long, and eight inches tall while having a lift capacity of at least three tons.

25. The lifting apparatus of claim 14 wherein the lifting apparatus is sized to fit within a compact space measuring four inches wide, fifteen inches long, and five inches tall while having a lift capacity of at least two tons.
